(19) United States
(12) Patent Application Publication
(10) Pub. No.: US 2010/0269383 A1
(43) Pub. Date: Oct. 28, 2010

(54) POWER MANAGEMENT SYSTEM CONTROLLER

(76) Inventor: Eugene C. Nifenecker, New York, NY (US)

Correspondence Address: MCGUIREWOODS, LLP, 1750 TYSONS BLVD, SUITE 1800, MCLEAN, VA, 22102, US

(21) Appl. No.: 12/767,471

(22) Filed: Apr. 26, 2010

Related U.S. Application Data
(60) Provisional application No. 61/172,927, filed on Apr. 27, 2009.

(51) Int. Cl. G09F 13/04; H05B 41/16; H05B 39/00; H05B 37/02

(52) U.S. Cl. 40/541; 315/287; 315/185 R; 315/152

(57) ABSTRACT

An apparatus and method provides for managing solar power to a LED illumination device such as a street sign so that the power from a power storage device is monitored and variations in applied power to the LED device can be dynamically made to preserve power or increase power as appropriate. A controller may control the power management based on preprogrammed time periods, environmental factors, and solar availability. Historical tracking of available power may provide a basis for computing available power.

### CROSS REFERENCE TO RELATED APPLICATIONS

This application claims priority to U.S. Provisional Application No. 61/172,927 entitled POWER MANAGEMENT SYSTEM CONTROLLER, filed Apr. 27, 2009, the disclosure of which is incorporated by reference herein in its entirety.

### BACKGROUND

1.0 Field of the Invention

The invention is directed generally to a system and method for power management related to solar energy powered lighting and, more specifically, to a system and method for optimized power management related to solar energy powered lighting including LED technology and including intelligent control of the power utilization.

2.0 Related Art

Illumination of commercial and residential signs and devices almost always involve commercial power sources. For example, commercial advertising may utilize neon, candescent or fluorescent lighting technology that may require substantial power to illuminate these types of signage. Moreover, the overall cost of installation and ongoing costs of commercial energy may be substantial. In most applications such signage or devices operated for a fixed and predetermined period of time at maximum power levels, without regard to environmental factors or costs.

Currently, lighting of signs, billboards, and the like, typically require commercial power hookups and access to hookup of commercial power. Renewable energy concepts have been slow to be utilized as a replacement for such applications. In part, this may be attributable to a lack of consideration of specific application needs and limitations, and use of specific related installation specific information.

Deployment of solar based solutions has been slow to be implemented. Those that exist do not provide for optimized management of the power utilization based on location, environmental factors, and other parameters. Nor do the current solutions provide for optimal power utilization for the components involved.

### SUMMARY OF THE INVENTION

The invention addresses the above short-comings and provides for an effective and cost efficient technique for supplying illuminated signage power by the sun. In one aspect, an apparatus for providing and managing solar generated power is provided that includes at least one photo voltaic (PV) panel configured to produce electrical power from sunlight, a power storage device configured to store power from the at least one PV panel, at least one light emitting diode (LED) illumination component configured to be powered by the stored power and a controller configured to control the power from the power storage device to the LED illumination component based at least in part on an environmental condition, wherein the power to the LED illumination device is pulse width modulated thereby decreasing power consumption to the LED illumination component.

In another aspect, a method for providing and managing solar generated power is provided that includes providing at least one photo voltaic (PV) panel configured to produce electrical power from sunlight, providing a power storage device configured to store power from the at least one PV panel, providing at least one light emitting diode (LED) illumination component configured to be powered by the stored power and providing a controller configured to control the power from the power storage device to the LED illumination component based at least in part on an environmental condition, wherein the power to the LED illumination device is pulse width modulated thereby decreasing power consumption to the LED illumination component.

In another aspect, an apparatus for providing and managing solar generated power is provided that includes at least one photo voltaic (PV) panel configured to produce electrical power from sunlight, a power storage device configured to store power from the at least one PV panel, at least one light emitting diode (LED) component configured to be powered by the stored power and a controller configured to control the power from the power storage device to the LED illumination component based on at least one of pre-programmed periods or available power, wherein the power to the LED illumination device is pulse width modulated thereby decreasing power consumption to the LED illumination component.

### BRIEF DESCRIPTION OF THE DRAWINGS

The accompanying drawings, which are included to provide a further understanding of the invention, are incorporated in and constitute a part of this specification, illustrate embodiments of the invention, and together with the detailed description, serve to explain the principles of the invention. No attempt is made to show structural details of the invention in more detail than may be necessary for a fundamental understanding of the invention and the various ways in which it may be practiced. In the drawings:

FIG. 1 is a block diagram showing various components that may be included in an embodiment of a light power management system, configured according to principles of the invention;

FIG. 2 is a schematic showing certain components of an embodiment of a light power management system, configured according to principles of the invention;

FIG. 3 is an exemplary illustration showing a solar powered traffic sign, configured and managed according to principles of the invention;

FIGS. 4A, 4B are exemplary illustrations showing a commercial signage, configured and managed according to principles of the invention;

FIGS. 5A, 5B and 5C are exemplary illustrations of a commercial signage, configured and managed according to principles of the invention; and

FIG. 6 is an exemplary illustration of a commercial signage, configured according to principles of the invention.

### DETAILED DESCRIPTION OF THE INVENTION

It is understood that the invention is not limited to the particular methodology, protocols, etc., described herein, as these may vary as the skilled artisan may recognize. It is also to be understood that the terminology used herein is used for the purpose of describing particular embodiments only, and is not intended to limit the scope of the invention. It is also to be noted that as used herein and in the appended claims, the singular forms “a,” “an,” and “the” include the plural reference unless the context clearly dictates otherwise. Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

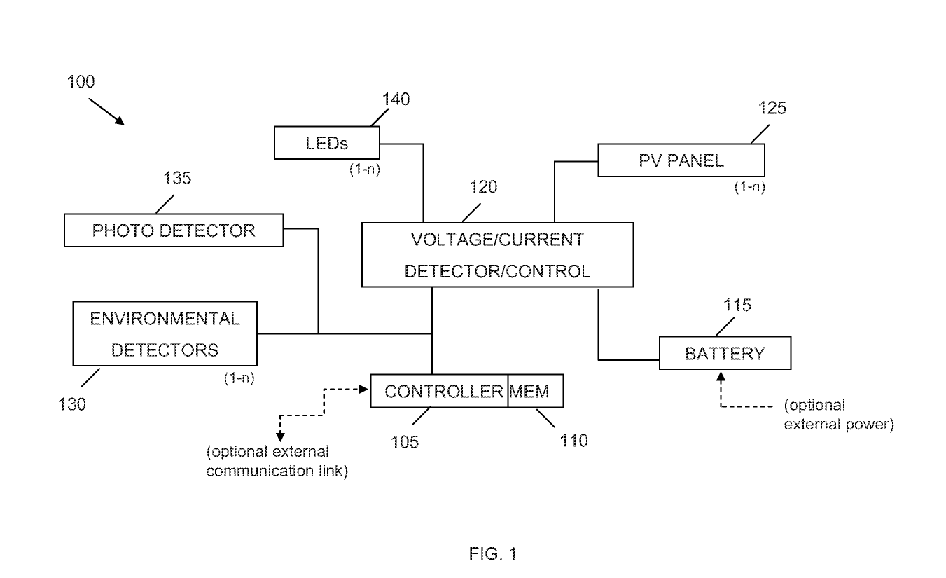

The system and method of the invention generally includes providing for power management related to solar energy powered lighting for optimized power management related to solar energy powered lighting including LED technology with intelligent control of the power utilization. FIG. 1 is a block diagram showing various components that may be included in an embodiment of a light power management system, configured according to principles of the invention, and generally denoted by reference numeral 100. The system 100 may include a controller 105 with supporting memory 110 for software execution and storage, a power storage device such as a rechargeable battery 115 for powering the system 100. The system 100 may further comprise a voltage/current detector and control circuitry 120 for monitoring and controlling voltage and current levels as described herein, one or more photovoltaic (PV) panels 125 for conversion of sunlight to electricity, one or more environmental detectors (1-n) 130 for detecting environmental conditions such as, for example, a humidity detector and a temperature detector, a photo detector 135, which may be a type of environmental detector, and one or more light emitting diode (LED) panels 140. One or more of these components may be combined. For example, the controller 105 with memory 110 and the voltage/current detector and control circuitry 120 may be combined.

The system 100 may comprise several logical layers including:
1. Core technology.
   Integrated circuit board hardware.
   Embedded, highly configurable solar-powered system management software.
2. Solar power components.
Integrated circuit board hardware.
   Solar photo voltaic (PV) panels. (e.g., high-capture rate crystalline silicon, thin film or related materials).
   Energy efficient, LED light and light arrays.
   High performance batteries (which may include a bio-degradable, environmental friendly gel type).
   Wire harnesses and connectors.
   Rugged construction.
3. Optimized system design and packaging.
   Configured for minimized PV panel, battery footprint and cost.
   Configured for maximized lighting brightness and duration (e.g., about eight days without sunlight for recharging).
4. Solar-powered applications
   Illumination signage
      Street intersection signs
      Evacuation signs
      Directional and way finding signs
      Welcome signs
   Illuminated Billboards
   Lighting
      Streetlights
      Parking lot lights
      Park lights
      Other similar lights

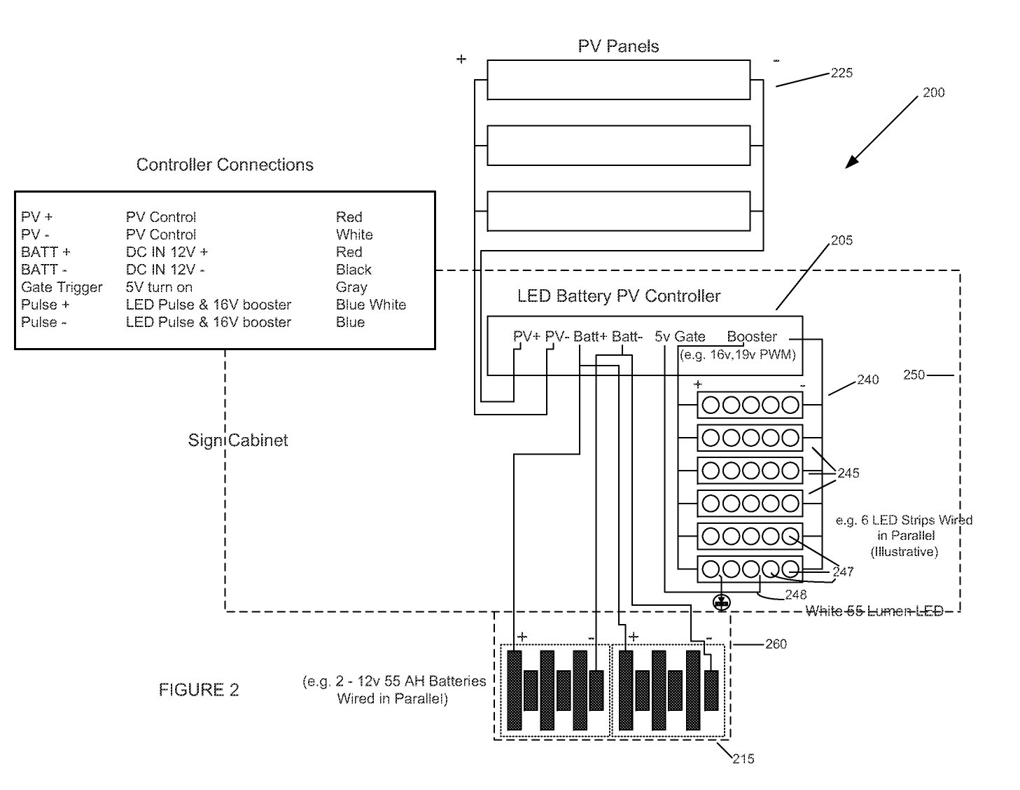

FIG. 2 is a schematic showing certain components of an embodiment of a light power management system, configured according to principles of the invention, generally denoted by reference numeral 200. The system 200 may include power storage 215, which may comprise 2-12 v 55 AH batteries wired in parallel, for example, perhaps housed in housing 260. Other types or numbers of batteries may be utilized, which may be used in combination with super capacitors, in some applications. The system 200 may further include a photovoltaic controller 205 for controlling charging of the power storage 215, controlling discharge of power from the power storage 215, and application of power to the LED illumination component 240. The LED illumination component 240 may comprise a plurality of LED strips 245 wired in parallel as shown. Each LED strip 245 may comprise a plurality of LEDs 247 in series, and may be operated at a boosted range, typically about 16 v or about 19 v for improved efficiencies, or may be operated at a voltage level in a range from about 16 v to about 19 v. The voltage level may be boosted over a level supplied by the power storage device. The LED strips 245 may be configured proximate to, adjacent to, or behind a portion of a sign to illuminate that portion (e.g., a letter or logo, etc.). A plurality of LED strips 245 may be utilized depending on the size and amount of signage that is needed to be illuminated.

The photovoltaic controller 205 may control power to the one or more LED strips 245 by using pulse width modulation (PWM) techniques to variably apply power in an efficient manner to the LED illumination component 240. Generally, a PWM variable-power scheme may switch the power quickly between fully on and fully off, for example, at a rate in tens or hundreds of kHz. The rate may be alterable by the photovoltaic controller 205, based on environmental factors, or available power, for example. The PV controller 205 may alter the frequency of the pulse width modulated power to change (increase or decrease) the effective operational power to the LED illumination component.

The voltage employed may be boosted from about 12V to about 16V or about 19V to improve efficiencies and/or to eliminate/minimize “lossy” components. The photovoltaic controller 205 may control power from the PV panels 225 to the power storage 215 for charging of the power storage 215.

The embodiment of FIG. 2 also illustrates a housing 250 which, in this example, is a sign cabinet for housing the PV controller 205 and the LED illumination component 240. In some applications, the housing 250 might include the power source 215. The housing 250 may be constructed to perform well in the harshest of conditions including hurricanes, extreme heat, and extreme cold. Moreover, the housing may be constructed to be highly resistant to vandalism and theft.

The LEDs 247 provide for the most energy and cost efficient performance. The LEDs 247 easily outperform and are usually more cost effective than fluorescent, incandescent, metal halide, mercury vapor, and neon sources, with a much longer life and consequently less frequent maintenance costs.

The system 100, 200 may be constructed to be competitive in the marketplace. The PV panels 125, 225 may be constructed with minimized PV panel footprint and costs. Moreover, the battery 115 and power storage 215 may be constructed with minimized footprint and cost. Moreover, the controller 105 and PV controller 205 may be configured to maximize lighting brightness and duration. This may be accomplished based on environmental factors and variable application of power to optimize energy usage, described more fully below. Moreover, the PV panels 125, 225 in most applications do not need to be large PV panels.

The controller 105 and PV controller 205 may be programmed with data that is specific to an installation location. The data includes solar-days information so that an effective solar gain for a specific geographic location can be configured so that optimal performance of the light output can be achieved. The solar-days information may include, but not limited to, data related to hours of sunlight throughout the year, e.g., on a daily basis, a rolling average of availability of sunlight so that low sun-light conditions may be statistically projected so that the power consumption may be altered accordingly to adjust to the projection, sunlight intensity data throughout the year.

The controller 105 and PV controller 205 may also be programmed so that one or more preference periods may be established based on customer desires, so that select hours might be given higher preference than others. For example, a period of four hours after dusk may have higher preference than other hours and may receive a high power allotment, hence brighter illumination (i.e., for a signage application). The lower preference periods may be allocated a lower power allotment, hence dimmer illumination. Other periods may be established as appropriate. Based on geographic solar-days information, the power allocation may be allocated to the periods based on total expected overall available power. So, in a phase where lower solar availability is being experienced or projected, the power allocations for each period may be recalculated accordingly, and applied. In certain situations, where total available power might be projected as being low, one or more periods may include being turned off to conserve overall power.

A photo detector 135 may be utilized to determine low light periods such as after dusk. Moreover, it may be utilized to determine low light levels during daylight hours, in which case, the controller 105 and PV controller 205 may elect to remain in an off mode or reduced power mode. The hours of the day may be monitored by the controller 105 and PV controller 205 on an ongoing basis using the photo detector 135, so that unanticipated low light periods such as during a thunderstorm during day hours, for example, might not cause power to be utilized. The PV controller 205 may track power maximum usage and power minimum usage to approximate sunrise or sunset over a sampled time period. A real-time clock may be included as part of the controller 105, PV controller 205, or as one of the environmental detectors 130.

Moreover, other environmental detectors 130 such as a humidity or rain detector might be used to confirm rain periods, so that the controller 105 and PV controller 205 might decide based on application programming whether or not power should be applied. Moreover, a environmental detector such as a fog detector may be employed for signage/devices related to bad weather operations, in which case the controller 105 and PV controller 205 may make a decision to apply or vary power, or not.

In another aspect, the controller 105 and PV controller 205 may be programmed to vary power to the LED illumination component 245 so that visual effects such as flashing or incrementally progressive brighter light effect might be delivered. This may be time related, or environmentally based.

Referring to FIG. 2, the PV controller 205 may be configured to interact and work with the one or more LED strips 245 that may be wired in parallel for a given lighting application. Each strip may comprise:
Five LEDs placed in series.
Constant current circuitry to bias the LEDs 247 per the manufacturer's recommended current.
On-Off Led control for local duty-cycling of the LEDs 247, resulting in reduced radio frequency (RF) emissions.
Feedback from the LED bias network to the controller 205.

The signals between the PV controller 205 (or controller 105) and the LED strip 245 may include:
Power.
Ground.
Enable (on-off pulse width modulation duty cycle).
A “current ok” signal back from the Led strips 245.

Many manufacturers utilize lighting components that operate at 12 VDC and include two or three LEDs placed in series with a current-limiting resistor. The LED strips 245 place five LEDs 247 in series for operating at a boosted voltage, preferably in the about 16V to about 19V range, to eliminate most “lossy” components.

The PV controller 205 (or controller 105) may be configured to apply LED voltage at a nominal value and then may begin to increment it higher and higher. When the voltage is high enough to bias the constant current circuit on the LED strips 245, a “current ok” signal 248 (a feedback signal) may be set high. The point at which this occurs is typically at the manufacturer's rated current and it is also the minimum voltage necessary to forward bias the string of five LEDs 247 on the LED strips 245. The feedback signal when it changes is indicative that the applied voltage is sufficient to bias a constant current on the LED illumination device, i.e., the LED strips 245.

The circuit automatically may compensate for differences in forward bias voltages among each individual LED 247 and also compensates for different brands or mixed-color LEDs, so long as they have the same nominal current rating. Any additional voltage applied beyond the “current-ok” level results in wasted power dissipated in any MOSFET turn-on circuit; freezing the voltage increase when the “current-ok” signal trips, results minimum losses.

Each of the “current-ok” signal strips from the parallel LED strips 245 may be electrically diode-ORed together back the PV controller 205. The PV controller 205 may continue to boost the LED voltage until it detects a high “current-ok” signal 248. The point at which this occurs may represent the minimum voltage necessary to bias all of the parallel LED strips 245 collectively, without wasting any additional power. Manufacturers that apply a set voltage to a load waste a high proportion of power in a current/voltage limiting network or as additional waste heat in the LEDs 247, due to variations in their forward bias voltages. The configuration described herein avoids these pitfalls.

The power management provided by the PV controller 205 or controller 105 may include:
Monitoring of the incoming photovoltaic voltage and current, in order to track total incoming power.
Monitoring of the light load outgoing voltage and current, in order to track total outgoing power.
Estimation of power storage (e.g., battery) capacity based on an analysis of incoming power, outgoing power and temperature for providing a more accurate reading, as compared with techniques employed prior to the invention that is based only on the battery voltage.
Since a power storage unit, such as a battery, may experience repeated charge-discharge cycles, and as it ages, its storage capacity usually changes. Previous capacity calculations and associated data may be considered using feedback from the charge routine. Whenever the charge routine reports that a power storage unit is fully charged, any delta between the capacity estimates and the “full” notification may be “zeroed out.” That is, the capacity may be essentially recalibrated. This provides for a process that continuously updates and adapts to a power storage unit, such as a battery, changing capacity. This may provide for more accurate power management results over the life of the system.
PV controller 205 or controller 105 may increase or decrease brightness according to recent net power gains or losses, and may use history data to provide an estimation of the likelihood of better charging over the coming days.

A software implemented process for detecting and avoiding light pollution without a real-time clock may include:
Tracking the cycle of photovoltaic (PV) input over time. For a “dark” site, the PV voltage may roughly follow a sign wave between the brightest and the darkest portion of the day. At an ideal site, the peak may be maximum PV voltage and the trough zero volts.
Since a site with light pollution that is greater than the designated sunset trip voltage might fool a sign into never turning on, an ambient light detector may be tricked into thinking that there is an “eternal” day. Timers may also fail since there may be no clear mechanism to determine the location of the proper sunrise and sunset points. However, by tracking the PV voltage over about 24 hours and determining the delta between sunset trip point and the PV minimum value, the level of light pollution can be estimated and accounted for determining a most probable actual sunset and sunrise time. Continuously, or near continuously, performing this process, may provide a basis for adjusting to changes in daylight durations through out the year, as seasons change.
Once determined, a light pollution value may be used to automatically shift the sunset and sunrise detection voltages to accommodate changing levels of light pollution. Each day, the next day's value may be estimated and set.
Additional compensation may be provided to detect light pollution that arrives before or after a sunset has been detected, to prevent false turn-offs during the night.
Rate of change detection may also be provided to differentiate ambient light changes due to transients (e.g., car headlights) versus substantially more steady-state environmental light pollution.
False sunrise detection may also be provided. Shifting of the sunrise value, in correlation with a shifted sunset, might result in wasted power due to lights being left on too long in the morning. The process may detect pollution that “goes away” in pre-dawn conditions (e.g., automatic lights going off) and provides for reverting back to a normal turn-off, preventing wasted power.

The power management system 100, 200 may provide for:
Monitoring the level and rate of power from the PV panel(s).
Regulating the amount of power coming in from the PV panel(s).
Cutting off power when the incoming power may be excessive.
Converting power to DC power for storage and use.
Boosting the DC power for delivery to the LED strips.
Releasing power to the LED strips in defined increments when according to a signal; and maintaining the power at a specific level according to the signal.
Boosting the DC power to the LED strips.
Utilizing highly efficient LEDs.
Utilizing LEDs that are highly bright.
Utilizing a LED strip(s) to manage and monitor the level of power being consumed.
Balancing the electric load across an entire LED strip.
First and last LEDs in a strip to receive essentially equal power to maintain near equal life expectancy for each LED thereby minimizing “hot” spots or “cold” spots in any illumination.
Utilize pulse modulation to deliver power to the LEDs thereby conserving power while driving the LEDs at an efficient and effective light output mode.
Provide for increasing or decreasing the rate of pulse modulating to manage power consumption based on predetermined parameters, environmental factors, and/or available/anticipated power.
Provide for controlling intermittent flashing/blinking of the LEDs; including controlling the cycle of blinking.
Provide for use of 6, 12, 18, 24 volt LEDS, according to applications.
Provide for power off at dawn/morning.
Provide for power on at dusk/evening.
Provide for recognizing ambient light and light pollution.
Provide for detecting environmental conditions such as humidity, temperature and/or fog.
Provide for programmable defined periods for on/off (e.g., by hour, by day of week, etc.).
Provide for a 24/7 clock program or input.
Constructed to function in high temperatures, low temperature, wet/damp/humid environments.
Lighting sequencing to be essentially perpetual and renewable relative to power storage.
Provide for an ability to estimate and calculate probable available power based on consumption, charging rate, environmental factors, and solar day data for a specific location, in any combination.
Provide an ability to control power sequencing among a plurality of LED strips so that they are synchronized, or alternatively, different sets of LED strips may not be synchronized. This may be useful if different letters in a sign require different or the same on-off timing rates, for example. Moreover, any power reduction may need to be coordinated among different LED strips so that a uniform appearance may occur. That is, avoiding dimming one letter of a sign before another may be avoided (or achieved, depending on desired circumstances).
Minimizing the size (footprint) of the PV panels and power storage for the intended application.
Minimizing power consumption by determining dynamically the minimum voltage required to power the LED strips optimally.
Provide for remote programming and remote maintenance including self-testing of system components.

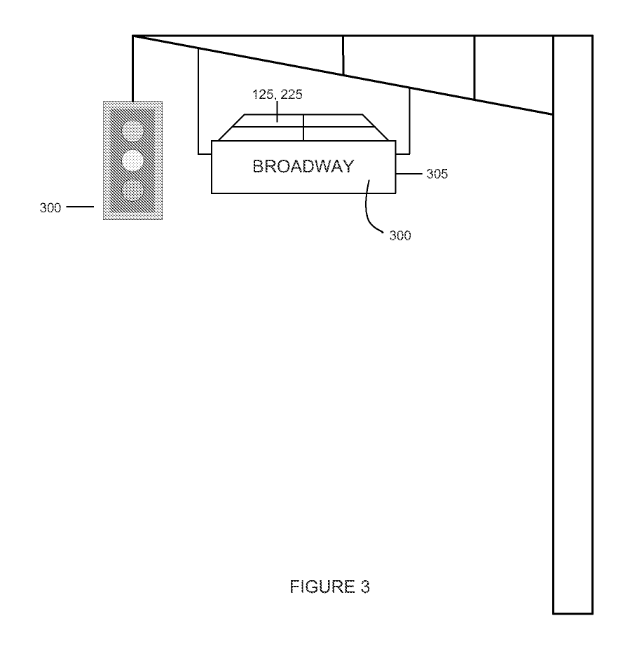

FIG. 3 is an exemplary illustration showing a solar powered traffic sign, configured and managed according to principles of the invention. The traffic sign 300 providing an illuminated “BROADWAY” may be illuminated by LED strips (e.g., LED strips 245) located behind the letters of “BROADWAY” within the housing 305, and may be configured and controlled by the principles and components of the invention previously described herein. As shown, a PV panel 125, 225 resides atop of the traffic sign 300. A power storage (e.g., power storage 215, or battery 115) and PV controller 205 may be housed with the housing 305 also. Optionally, the traffic sign 300 may be configured with an interface for connecting to a communication link for remote access for programming and/or maintenance. Also, optionally, an interface may be provided for interfacing to external power for charging the power storage.

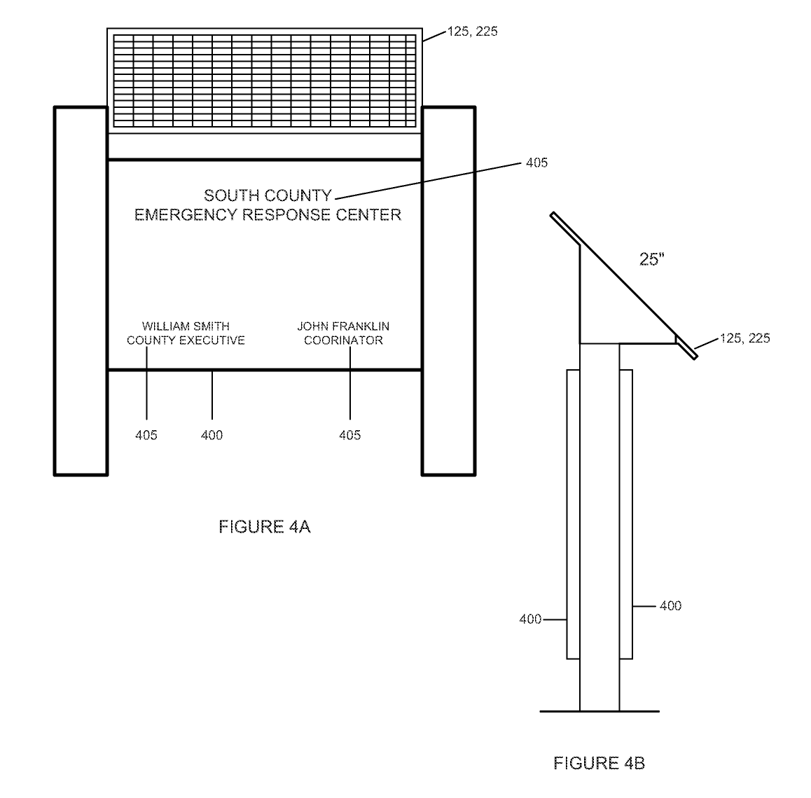

FIGS. 4A, 4B are exemplary illustrations showing a commercial signage, configured and managed according to principles of the invention. The signage 400 may include an embodiment of the power manage system described herein with the LED strips 245 (not shown explicitly in this example) may be located behind or adjacent to the lettering 405 of the signage 400. The LED strips 245 may be oriented so that they show through both sides of the signage 400, or two or more sets of LED strips 245 may be employed, perhaps one set or more for each side of the sign. The PV panel 125, 225 is shown mounted atop of the commercial signage 400. In this example, the PV panel 125, 225 is shown oriented at a 25 degree angle, as pre-configured as appropriate for the exemplary geographic location of the signage 400. Other angles may be employed based on geographic location and/or signage alignment.

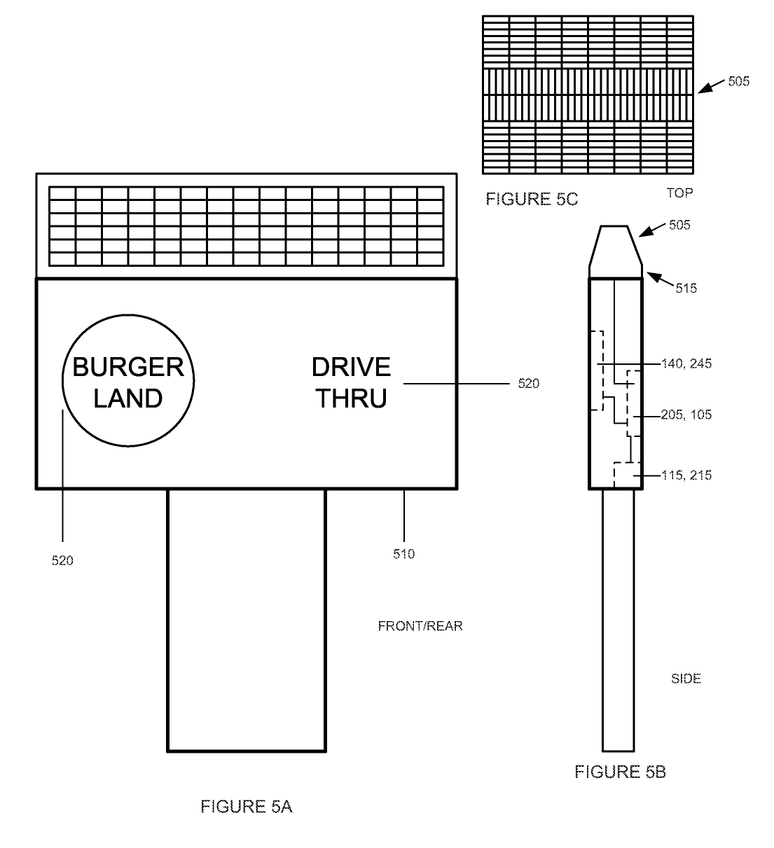

FIGS. 5A, 5B and 5C are illustrations of a commercial signage, configured and managed according to principles of the invention. In this example, the PV panels 505 may take on a multi-surface configuration that forms a top of the signage. The functional components, e.g., PV controller 205 or controller 105, battery 115 or power storage 205, may reside within the signage 510 or within the PV panel housing 515. The LED strips (e.g., LED strips 245) may be located behind the lettering/logo 520 that may be formed in the signage 510 wall. Certain internal portions of the sign may be coated with a highly reflective coating or paint (e.g., Spaylat Star-Brite Light Enhancing paint) to aid in directing light towards the portions of the signage that require illumination (e.g., the lettering/logo 520).

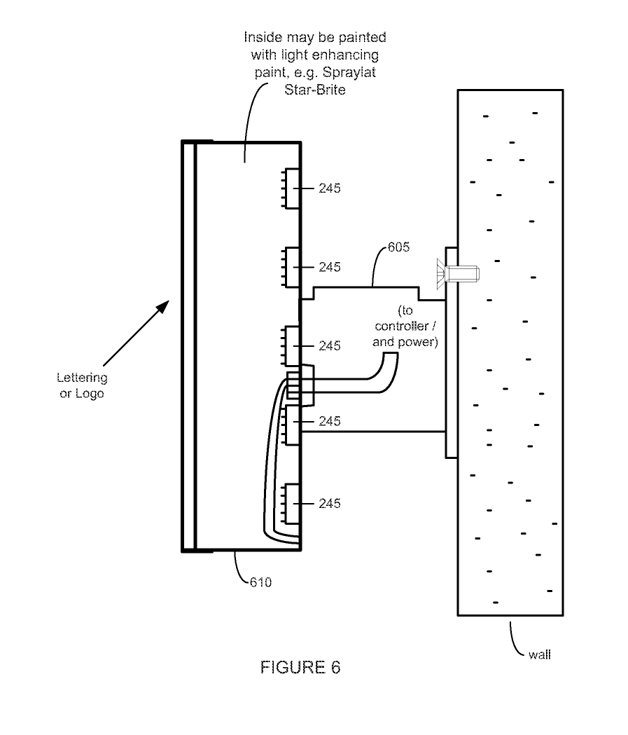

FIG. 6 is an exemplary illustration of a commercial signage, configured according to principles of the invention. The signage 610 may include a front surface with lettering or logos designed into the front surface that permit passage of light to form the lettering or logos. The signage may be mounted to an existing wall, perhaps with a raceway 605 between the signage 610 and the wall. LED strips 245 may be located proximate or behind any lettering or logos positioned so that optimal light emissions from the LED strips 245 are directed towards the lettering or logos. In this example, the controller 105, 205 and the power storage unit or battery may reside outside the actual signage housing and electrically connected by a wiring harness through the raceway 605. The internal surfaces of the signage 610 may be coated with a light enhancing paint.

While the invention has been described in terms of exemplary embodiments, those skilled in the art may recognize that the invention can be practiced with modifications in the spirit and scope of the appended claims. These examples given above are merely illustrative and are not meant to be an exhaustive list of all possible designs, embodiments, applications or modifications of the invention.

I claim:

1. An apparatus for providing and managing solar generated power, comprising:
at least one photo voltaic (PV) panel configured to produce electrical power from sunlight;
a power storage device configured to store power from the at least one PV panel;
at least one light emitting diode (LED) illumination component configured to be powered by the stored power; and
a controller configured to control the power from the power storage device to the LED illumination component based at least in part on an environmental condition,
wherein the power to the LED illumination device is pulse width modulated thereby decreasing power consumption to the LED illumination component.

2. The apparatus of claim 1, wherein each of the at least one LED illumination component comprises a plurality of LEDs arranged in electrical series.

3. The apparatus of claim 1, wherein the controller is configured to increase applied voltage to the at least one LED illumination component and monitor a feedback signal from the at least one LED illumination component for setting an optimal voltage level to the at least one LED illumination component.

4. The apparatus of claim 3, wherein the feedback signal is indicative that the applied voltage is sufficient to bias a constant current on the at least one LED illumination component.

5. The apparatus of claim 3, wherein the controller maintains the applied voltage at a present value based on the feedback signal changing value.

6. The apparatus of claim 3, wherein the applied voltage is a level in the range of about 16 volts to about 19 volts.

7. The apparatus of claim 3, wherein the applied voltage is boosted from a voltage level supplied by the power storage device.

8. The apparatus of claim 1, wherein the environmental condition includes at least one of temperature, fog, light pollution, or ambient light levels.

9. The apparatus of claim 1, wherein the controller is further configured to control the power to the LED illumination component based on preprogrammed timed periods.

10. The apparatus of claim 1, wherein the controller monitors power consumption to the LED illumination component and alters power to the LED illumination component based upon available power.

11. The apparatus of claim 1, wherein the controller alters the frequency of the pulse width modulated power to change the effective operational power to the LED illumination component.

12. The apparatus of claim 1, further comprising a housing to house the at least one light emitting diode (LED) illumination component, the at least one light emitting diode (LED) illumination component providing backlight to illuminate a sign.

13. The apparatus of claim 1, further comprising one of: a communication interface for programming the controller and an interface for an external power source for charging the power storage device.

14. A device that includes the apparatus of claim 1.

15. A method for providing and managing solar generated power, comprising the steps of:
providing at least one photo voltaic (PV) panel configured to produce electrical power from sunlight;
providing a power storage device configured to store power from the at least one PV panel;
providing at least one light emitting diode (LED) illumination component configured to be powered by the stored power; and
providing a controller configured to control the power from the power storage device to the LED illumination component based at least in part on an environmental condition,
wherein the power to the LED illumination device is pulse width modulated thereby decreasing power consumption to the LED illumination component.

16. The method of claim 15, wherein the step of providing at least one LED illumination device includes providing a plurality of LEDs arranged in electrical series.

17. The method of claim 15, wherein the step of providing a controller provides a controller configured to increase applied voltage to the at least one LED illumination component and monitor a feedback signal from the at least one LED illumination component for setting an optimal voltage level to the at least one LED illumination component.

18. The method of claim 17, wherein the feedback signal is indicative that the applied voltage is sufficient to bias a constant current on the at least one LED illumination component.

19. The method of claim 15, wherein the step of providing a controller provides a controller that maintains the applied voltage at a present value based on the feedback signal changing value.

20. The method of claim 15 wherein the applied voltage is a level in the range of about 16 volts to about 19 volts.

21. The method of claim 15, wherein the environmental condition includes at least one of a temperature condition, a fog condition, a light pollution condition, or an ambient light level condition.

22. The method of claim 15 further comprising controlling the applied power to the LED illumination component based on a preprogrammed timed period.

23. The method of claim 15, further comprising altering the frequency of the pulse width modulated power to change effective operational power to the LED illumination component.

24. A device constructed according to the method of claim 15.

25. An apparatus for providing and managing solar generated power, comprising:
at least one photo voltaic (PV) panel configured to produce electrical power from sunlight;
a power storage device configured to store power from the at least one PV panel;
at least one light emitting diode (LED) component configured to be powered by the stored power; and
a controller configured to control the power from the power storage device to the LED illumination component based on at least one of pre-programmed periods or available power,
wherein the power to the LED illumination device is pulse width modulated thereby decreasing power consumption to the LED illumination component.

26. The apparatus of claim 25, wherein the controller increases a voltage level to the at least one LED component until a feedback signal is received thereby stopping and maintaining the voltage level at a constant value.

27. The apparatus of claim 25, wherein the controller alters a frequency of the pulse width modulated power to increase or decrease effective operational power to the LED illumination component.

28. The apparatus of claim 25, wherein the controller tracks power maximum usage and power minimum usage to approximate sunrise or sunset.
